(19) United States
(12) Patent Application Publication
(10) Pub. No.: US 2013/0318787 A1
(43) Pub. Date: Dec. 5, 2013

(54) MANUFACTURING A FAMILY OF AIRFOILS

(71) Applicants: Seth J. Thomen, Colchester, CT (US); Wieslaw A. Chlus, Wethersfield, CT (US)

(72) Inventors: Seth J. Thomen, Colchester, CT (US); Wieslaw A. Chlus, Wethersfield, CT (US)

(21) Appl. No.: 13/489,074

(22) Filed: Jun. 5, 2012

(51) Int. Cl. B23P 15/02

(52) U.S. Cl. 29/889.7

(57) ABSTRACT

A method of manufacturing a family of airfoils includes providing a plurality of airfoil blanks of identical geometry, selecting a first airfoil geometry from a family of airfoil geometries, selecting a second, different airfoil geometry from the family of airfoil geometries, machining a first one of the plurality of airfoil blanks to the first airfoil geometry to produce a first airfoil of the family of airfoil geometries, and machining a second, different one of the plurality of airfoil blanks to the second airfoil geometry to produce a second, different airfoil of the family of airfoil geometries

### BACKGROUND

This disclosure relates to improvements in manufacturing a family of similar airfoils.

Airfoils, such as rotatable blades and static vanes, are known and used in gas turbine engines. Typically, an airfoil is cast from a metallic material to form a near-net geometry airfoil relative to the final, desired geometry. The cast airfoil is then machined to the final geometry.

Over the life of the gas turbine engine, the airfoils may require replacement. New replacement airfoils are therefore cast and machined in the same manner as the earlier airfoils. The replacement airfoils have the same geometry as the earlier airfoils for proper assembly and operation in the engine.

In some instances, the gas turbine engine design has several models or variations that are substantially similar but have certain components that differ. As an example, corresponding airfoils of the engine variations (e.g., turbine blades, vanes, etc.) may utilize airfoils of differing geometries. Therefore, a replacement airfoil that is designed for one engine variation will not fit into an engine variation that uses a different geometry airfoil. Moreover, each different airfoil geometry requires a casting tool that is designed for its individual geometry.

### SUMMARY

A method of manufacturing a family of airfoils according to an exemplary aspect of the present disclosure includes (a) providing a plurality of airfoil blanks of identical geometry, (b) selecting a first airfoil geometry from a family of airfoil geometries, (c) selecting a second, different airfoil geometry from the family of airfoil geometries, (d) machining a first one of the plurality of airfoil blanks to the first airfoil geometry to produce a first airfoil of the family of airfoil geometries, and (e) machining a second, different one of the plurality of airfoil blanks to the second airfoil geometry to produce a second, different airfoil of the family of airfoil geometries.

In a further non-limiting embodiment, each of the family of airfoil geometries has an airfoil portion geometry, and the respective airfoil portion geometries are identical to each other.

In a further non-limiting embodiment of any of the foregoing examples, each of the family of airfoil geometries has a platform geometry, and the respective platform geometries are different from each other.

In a further non-limiting embodiment of any of the foregoing examples, each of the plurality of airfoil blanks has a platform portion defining an envelope encompassing the respective platform geometries.

In a further non-limiting embodiment of any of the foregoing examples, the machining of the first one of the plurality of airfoil blanks includes machining the platform portion of the first one of the plurality of airfoil blanks and the machining of the second one of the plurality of airfoil blanks includes machining the platform portion of the second one of the plurality of airfoil blanks.

In a further non-limiting embodiment of any of the foregoing examples, each of the family of airfoil geometries has a first portion geometry and a different, second portion geometry, the respective first portion geometries are identical to each other and the respective second portion geometries are different from each other.

In a further non-limiting embodiment of any of the foregoing examples, each of the plurality of airfoil blanks has a portion defining an envelope encompassing the respective second portion geometries.

In a further non-limiting embodiment of any of the foregoing examples, each of the first one of the plurality of airfoil blanks and the second one of the plurality of airfoil blanks includes a respective platform portion extending between opposed first and second sides that are machined in respective steps (d) and (e) to form respective platforms of the first airfoil and the second airfoil.

In a further non-limiting embodiment of any of the foregoing examples, step (d) includes machining a final distance X1 into the first side of the first one of the plurality of airfoil blanks and machining a final distance X2 into the second side of the first one of the plurality of airfoil blanks such that a ratio of X1/X2 is between 0.1 and 0.6.

In a further non-limiting embodiment of any of the foregoing examples, step (e) includes machining a final distance Z1 into the first side of the second one of the plurality of airfoil blanks and machining a final distance Z2 into the second side of the second one of the plurality of airfoil blanks such that a ratio of Z1/Z2 is between 2 and 9.

In a further non-limiting embodiment of any of the foregoing examples, step (d) includes machining a final distance X1 into the first side of the first one of the plurality of airfoil blanks and machining a final distance X2 into the second side of the first one of the plurality of airfoil blanks such that a ratio of X1/X2 is between 0.1 and 0.6, and wherein said step (e) includes machining a final distance Z1 on the first side of the second one of the plurality of airfoil blanks and machining a final distance Z2 on the second side of the second one of the plurality of airfoil blanks such that a ratio of Z1/Z2 is between 2 and 9.

A method of manufacturing a family of airfoils according to an exemplary aspect of the present disclosure includes providing an airfoil blank which includes an airfoil portion and a platform portion, selecting an airfoil geometry from a family of airfoil geometries, wherein each of the family of airfoil geometries has an airfoil portion geometry and a platform geometry and the respective airfoil portion geometries are identical to each other and the respective platform geometries are different from each other. The platform portion of the airfoil blank defines an envelope size encompassing the respective platform geometries. The platform portion of the airfoil blank are then to the selected airfoil geometry.

In a further non-limiting embodiment of any of the foregoing examples, the platform portion of the airfoil blank extends between opposed first and second sides, and the machining includes machining into each of the first and second sides.

In a further non-limiting embodiment of any of the foregoing examples, the machining includes machining a final distance X1 into the first side and machining a final distance X2 into the second side such that a ratio of X1/X2 is between 0.1 and 0.6.

In a further non-limiting embodiment of any of the foregoing examples, step (c) includes machining a final distance Z1 into the first side and machining a final distance Z2 into the second side such that a ratio of Z1/Z2 is between 2 and 9.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 shows a family of airfoils overlaid on one another.

FIG. 2 shows an airfoil blank having an envelope profile that encompasses two different airfoil geometries of a family of airfoil geometries.

### DETAILED DESCRIPTION

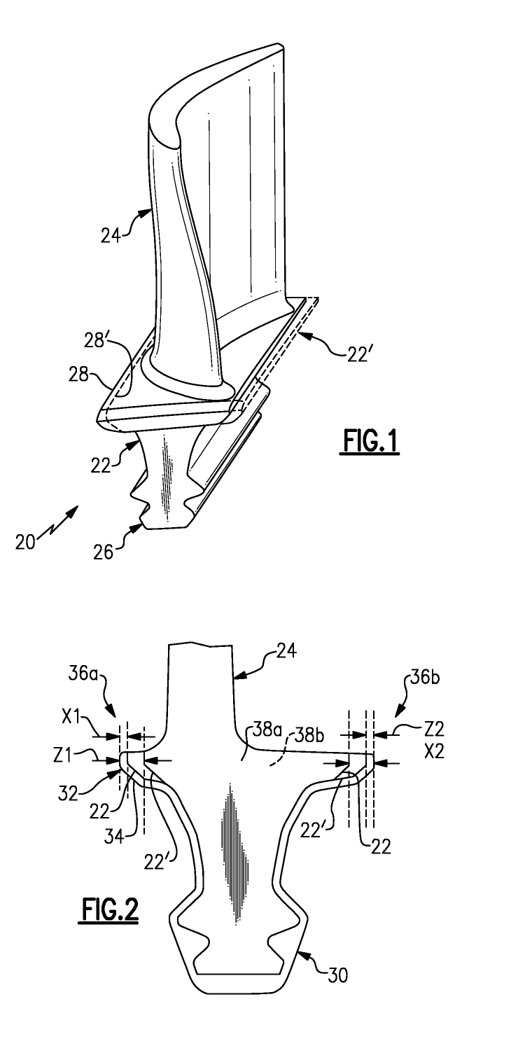

FIG. 1 shows a family 20 of airfoils 22/22′. For the purpose of this description, the airfoils 22/22′ are overlaid on one another to illustrate similarities and differences between the geometries of the airfoils 22/22′. It is to be understood, however, that although this example shows two airfoils, the family 20 can include additional airfoils.

Each of the airfoils 22/22′ has an airfoil portion 24 and a root portion 26. The airfoil portions 24 extend upwardly from platform portions 28/28′ of the respective airfoils 22/22′. The root portions 26 extend downwardly from the respective platform portions 28/28′. Thus, the airfoils 22/22′ in this example respectively include the airfoil portions 24, the root portions 26 and the platform portions 28/28′.

As can be appreciated from the overlaid airfoils 22/22′, the airfoil portions 24 and the root portions 26 of the airfoils 22/22′ are of identical geometry and the platform portions 28/28′ have different geometries.

The airfoils 22/22′ are members of the family 20. The term “family” as used in this disclosure means that all of the members have respective corresponding geometric portions (i.e., features) that are identical to each other and respective corresponding geometric portions that are different from each other. For the airfoils 22/22′, the airfoil portions 24 constitute corresponding geometric portions that are identical to each other. In this example, the root portions 26 also constitute corresponding geometric portions that are identical to each other. The platform portions 28/28′ constitute corresponding geometric portions that are different from each other. In other words, the members at least have corresponding first portion geometries (the airfoil portions 24 or the root portions 26 in the illustrated example) that are identical to each other and corresponding second portion geometries (the platform portions 28/28′ in the illustrated example) that are different from each other.

The airfoils 22/22′ may be cast in in a traditional manner using individual casting tools that are each designed for the individual geometries of the given airfoils 22/22′. Specifically, each airfoil 22/22′ would require a separate casting tool, thus increasing manufacturing expense. As will be described below, the airfoils 22/22′ can alternatively be manufactured more economically by casting somewhat oversized airfoil blanks in a single casting tool design, and then machining selected portions of the airfoil blanks to the geometries of the given airfoils 22/22′.

Referring to FIG. 2, the airfoils 22/22′ are manufactured from a plurality of airfoil blanks 30 (one shown). For example, the airfoil blanks 30 are cast from a superalloy material, such as a nickel-based superalloy, in a single casting tool and with a somewhat oversized geometry such that either of the airfoils 22/22′ can be machined from a single one of the airfoil blanks 30, depending upon which of the airfoils 22/22′ is needed.

In this example, since the platform portions 28/28′ have different geometries between the airfoils 22/22′, at least a corresponding platform portion 32 of the airfoil blank 30 is designed with an envelope 34 (i.e., outer profile) that is larger than the profiles of each of the platform portions 28/28′. Other portions of the blanks 30, such as the airfoil portions 24 in this example, are of identical geometry between the airfoils 22/22′ and thus can be cast to the final shape and do not require machining. Depending upon which of the airfoils 22/22′ is to be manufactured, either airfoil 22/22′ can be machined from the airfoil blank 30. Thus, to manufacture the family 20, only a single casting tool is required.

In a further example, a method of manufacturing the family 20 of airfoils 22/22′ includes providing a plurality of the airfoil blanks 30, which have identical geometry, and selecting airfoil geometries from a family of airfoil geometries. The family of airfoil geometries corresponds to the airfoils 22/22′, for example. Thus, to produce the airfoil 22, a first airfoil geometry of the family of airfoil geometries is selected and to produce the airfoil 22′ a second, different airfoil geometry from the family of airfoil geometries is selected.

For the first airfoil geometry, a first one of the plurality of airfoil blanks 30 is machined to the first airfoil geometry to thereby produce the airfoil 22. A second, different one of the airfoil blanks 30 is machined to the second airfoil geometry to produce the airfoil 22′. It is to be understood that the selection of the airfoil geometries and the machining of the airfoil blanks 30 can be conducted in parallel or at separate times, depending upon a need for each of the airfoils 22/22′.

Alternatively, a method of manufacturing the family 20 includes providing the airfoil blank 30 including the airfoil portion 24 and the platform portion 32, selecting an airfoil geometry from a family of airfoil geometries, where the platform portion 32 defines an envelope 34 encompassing the respective geometries of the platform portions 28/28′, and then machining the platform portion 32 to the selected airfoil geometry.

As shown in FIG. 2, the platform portion 32 of the airfoil blank 30 extends between first and second opposed circumferential sides 36a/36b and a first and second opposed axial sides 38a/38b. The terms “axial” and “circumferential” refer to the normal orientation of the airfoils 22/22′ within an engine, in which the airfoils 22/22′ are operable to rotate about a central axis of the engine.

In the example of the airfoils 22/22′, the platform portion 32 of the airfoil blank 30 is machined to different final distances on the first circumferential side 36a and the second circumferential side 36b, depending upon which of the airfoils 22/22′ is to be produced. To ensure that the platform portion 32 of the airfoil blanks 32 has a properly oversized envelope 34 to encompass the geometries of both platform portions 28/28′, given normal casting tolerances and machining tolerances, the geometry of the platform portion 32 is selected in correspondence with the amounts of material to be removed. The correspondence between the geometry of the platform portion 32 and the amounts of material to be removed is represented by ratios of amounts of material machined (i.e., removed) on opposed sides of the platform portion 32 to produce the given airfoils 22/22′.

For the airfoil 22, the platform portion 32 of the airfoil blank 30 is machined to a final distance X1 on the first circumferential side 36a and machined to a final distance X2 on the second circumferential side 36b, relative to the starting, as-cast size of the platform portion 32. Similarly, to produce the airfoil 22′, the platform portion 32 is machined to a final distance Z1 on the first circumferential side 36a and machined to a final second distance Z2 on the second circumferential side 36b. In this example, X1 is less than X2 and Z1 is greater than Z2. In a further example, a ratio X1/X2 is between 0.1 and 0.6 and a ratio Z1/Z2 is between 2 and 9.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A method of manufacturing a family of airfoils, the method comprising:
(a) providing a plurality of airfoil blanks of identical geometry;
(b) selecting a first airfoil geometry from a family of airfoil geometries;
(c) selecting a second, different airfoil geometry from the family of airfoil geometries;
(d) machining a first one of the plurality of airfoil blanks to the first airfoil geometry to produce a first airfoil of the family of airfoil geometries; and
(e) machining a second, different one of the plurality of airfoil blanks to the second airfoil geometry to produce a second, different airfoil of the family of airfoil geometries.

2. The method as recited in claim 1, wherein each of the family of airfoil geometries has an airfoil portion geometry, and the respective airfoil portion geometries are identical to each other.

3. The method as recited in claim 2, wherein each of the family of airfoil geometries has a platform geometry, and the respective platform geometries are different from each other.

4. The method as recited in claim 3, wherein each of the plurality of airfoil blanks has a platform portion defining an envelope encompassing the respective platform geometries.

5. The method as recited in claim 4, wherein the machining of the first one of the plurality of airfoil blanks includes machining the platform portion of the first one of the plurality of airfoil blanks and the machining of the second one of the plurality of airfoil blanks includes machining the platform portion of the second one of the plurality of airfoil blanks.

6. The method as recited in claim 1, wherein each of the family of airfoil geometries has a first portion geometry and a different, second portion geometry, the respective first portion geometries are identical to each other and the respective second portion geometries are different from each other.

7. The method as recited in claim 6, wherein each of the plurality of airfoil blanks has a portion defining an envelope encompassing the respective second portion geometries.

8. The method as recited in claim 1, wherein each of the first one of the plurality of airfoil blanks and the second one of the plurality of airfoil blanks includes a respective platform portion extending between opposed first and second sides that are machined in respective steps (d) and (e) to form respective platforms of the first airfoil and the second airfoil.

9. The method as recited in claim 8, wherein said step (d) includes machining a final distance X1 into the first side of the first one of the plurality of airfoil blanks and machining a final distance X2 into the second side of the first one of the plurality of airfoil blanks such that a ratio of X1/X2 is between 0.1 and 0.6.

10. The method as recited in claim 8, wherein said step (e) includes machining a final distance Z1 into the first side of the second one of the plurality of airfoil blanks and machining a final distance Z2 into the second side of the second one of the plurality of airfoil blanks such that a ratio of Z1/Z2 is between 2 and 9.

11. The method as recited in claim 8, wherein said step (d) includes machining a final distance X1 into the first side of the first one of the plurality of airfoil blanks and machining a final distance X2 into the second side of the first one of the plurality of airfoil blanks such that a ratio of X1/X2 is between 0.1 and 0.6, and wherein said step (e) includes machining a final distance Z1 on the first side of the second one of the plurality of airfoil blanks and machining a final distance Z2 on the second side of the second one of the plurality of airfoil blanks such that a ratio of Z1/Z2 is between 2 and 9.

12. A method of manufacturing a family of airfoils, the method comprising:
(a) providing an airfoil blank including an airfoil portion and a platform portion;
(b) selecting an airfoil geometry from a family of airfoil geometries, wherein each of the family of airfoil geometries has an airfoil portion geometry and a platform geometry, the respective airfoil portion geometries are identical to each other and the respective platform geometries are different from each other, the platform portion of the airfoil blank defining an envelope size encompassing the respective platform geometries; and
(c) machining the platform portion of the airfoil blank to the selected airfoil geometry.

13. The method as recited in claim 12, wherein the platform portion of the airfoil blank extends between opposed first and second sides, and the machining includes machining into each of the first and second sides.

14. The method as recited in claim 12, wherein said step (c) includes machining a final distance X1 into the first side and machining a final distance X2 into the second side such that a ratio of X1/X2 is between 0.1 and 0.6.

15. The method as recited in claim 12, wherein said step (c) includes machining a final distance Z1 into the first side and machining a final distance Z2 into the second side such that a ratio of Z1/Z2 is between 2 and 9.
